(19) United States
(12) Patent Application Publication
(10) Pub. No.: US 2013/0141351 A1
(43) Pub. Date: Jun. 6, 2013

(54) PORTABLE ELECTRONIC DEVICE AND METHOD FOR BRIGHTNESS CONTROL

(71) Applicants: Hideki Aisaka, Hino-shi (JP); Shinichi Shishino, Ome-shi (JP)

(72) Inventors: Hideki Aisaka, Hino-shi (JP); Shinichi Shishino, Ome-shi (JP)

(73) Assignee: KABUSHIKI KAISHA TOSHIBA, Tokyo (JP)

(21) Appl. No.: 13/541,266

(22) Filed: Jul. 3, 2012

(30) Foreign Application Priority Data
Dec. 2, 2011 (JP) 2011-264629

(51) Int. Cl. G09G 5/10; G06F 3/041

(52) U.S. Cl. 345/173

(57) ABSTRACT

According to one embodiment, a portable electronic device includes a housing with a built-in processor, a touchscreen display arranged on a surface of the housing, a temperature sensor configured to detect a temperature within the housing, a brightness adjustment module, and a brightness control module. The brightness adjustment module adjusts a brightness of the touchscreen display so as to set the touchscreen display to a brightness value specified by user operation. If the detected temperature is greater than or equal to a first threshold value, the brightness control module reduces an upper limit value of a brightness range applicable to the touchscreen display.

### CROSS-REFERENCE TO RELATED APPLICATIONS

This application is based upon and claims the benefit of priority from prior Japanese Patent Application No. 2011-264629, filed Dec. 2, 2011; the entire contents of which are incorporated herein by reference.

### FIELD

Embodiments described herein relate generally to a portable electronic device with a touchscreen display and a method for brightness control applied to the electronic device.

### BACKGROUND

In recent years, various electronic devices such as portable personal computers and cellular phones have been developed. Many of these electronic devices include a main body and a display section pivotally movably mounted on the main body.

Furthermore, these electronic devices use techniques to reduce power consumed by the electronic devices.

Portable electronic devices with touchscreen displays, such as tablet devices, have also been developed. A user can input commands, data, and the like to the portable electronic device by touching the touchscreen display with the user's finger.

Every effort has been being made to reduce the thickness of the tablet devices and to improve the functions thereof. This correspondingly tends to increase the surface temperature of a housing of the tablet device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the appearance of an electronic device according to an embodiment;

FIG. 2 is an exemplary block diagram showing a system configuration of the electronic device according to the embodiment;

FIG. 3 is an exemplary diagram showing a user interface for brightness adjustment provided in the electronic device according to the embodiment;

FIG. 4 is an exemplary diagram illustrating an example of a brightness control operation performed by the electronic device according to the embodiment;

FIG. 5 is an exemplary diagram illustrating another example of the brightness control operation performed by the electronic device according to the embodiment; and

FIG. 6 is an exemplary flowchart illustrating a procedure for a brightness control process that is carried out by the electronic device according to the embodiment.

### DETAILED DESCRIPTION

Various embodiments will be described hereinafter with reference to the accompanying drawings.

In general, according to one embodiment, a portable electronic device includes a housing with a built-in processor, a touchscreen display arranged on a surface of the housing, a temperature sensor configured to detect a temperature within the housing, a brightness adjustment module, and a brightness control module. The brightness adjustment module adjusts a brightness of the touchscreen display so as to set the touchscreen display to a brightness value specified by user operation. If the detected temperature is greater than or equal to a first threshold value, the brightness control module reduces an upper limit value of a brightness range applicable to the touchscreen display.

FIG. 1 is a perspective view showing the appearance of the portable electronic device according to the embodiment. The electronic device can be implemented as, for example, a tablet personal computer (PC) or a smartphone. The following description assumes that the portable electronic device is implemented as a tablet personal computer 10. As shown in FIG. 1, the tablet personal computer 10 comprises a computer main body 11 and a touchscreen display 17.

The computer main body 11 comprises a thin box-shaped housing. The housing contains a central processing unit (CPU) and various other devices. The CPU and various other devices are arranged on a printed circuit board provided within the housing.

A touchscreen display 17 with a backlight is arranged on a surface of the housing of the computer main body 11, for example, an upper surface of the housing. In other words, the touchscreen display 17 is mounted on the computer main body 11 so as to overlap an upper surface thereof.

The touchscreen display 17 incorporates a liquid crystal display (LCD) and a touchpanel. The touchpanel is provided over a screen of the LCD. The touchscreen display 17 can detect a position (also referred to as a touch position) on the display screen touched by an external object (a pen or a user's finger). The touchscreen display 17 may support a multitouch function to enable a plurality of touch positions to be simultaneously detected. The backlight is provided on a rear surface of the touchscreen display 17, that is, on a rear surface of the LCD. The backlight is a light source configured to illuminate the screen of the LCD. The brightness of the touchscreen display 15, that is, the brightness of the backlight, can be adjusted within a certain brightness range. The backlight comprises a great number of light emitting diodes (LEDs).

Furthermore, a camera 19 is arranged on an upper surface of the computer main body 11. The touchscreen display 17 is, for example, a display that is 10 inches or greater in size. In this case, for example, several tens of LEDs are included in the backlight. Thus, in the computer 10, power consumed by the touchscreen display 17 accounts for, for example, 60 to 70 percents of the power consumed by the computer 10. Moreover, the backlight consumes about half of the power consumed by the touchscreen display 17.

As described above, since the touchscreen display 17 is arranged on the housing of the computer main body 11, heat generated by the touchscreen display 17, more specifically, heat generated by the backlight, may significantly affect the surface temperature of the housing of the computer main body 11.

Thus, the computer 10 has a brightness control function to automatically reduce the brightness of the touchscreen display 17 according to the temperature within the housing in order to suppress an excessive rise in the surface temperature of the housing. In this case, basically, if the temperature within the housing is higher than a predetermined threshold value, the brightness of the touchscreen display 17 is automatically controlled to a lower level. The brightness of the touchscreen display 17 can be controlled by controlling the brightness of the backlight. The reduced brightness of the touchscreen display 17 enables a reduction in the amount of heat generated by the touchscreen display 17, more specifically, the amount of heat generated by the backlight. This allows the surface temperature of the housing to be reduced.

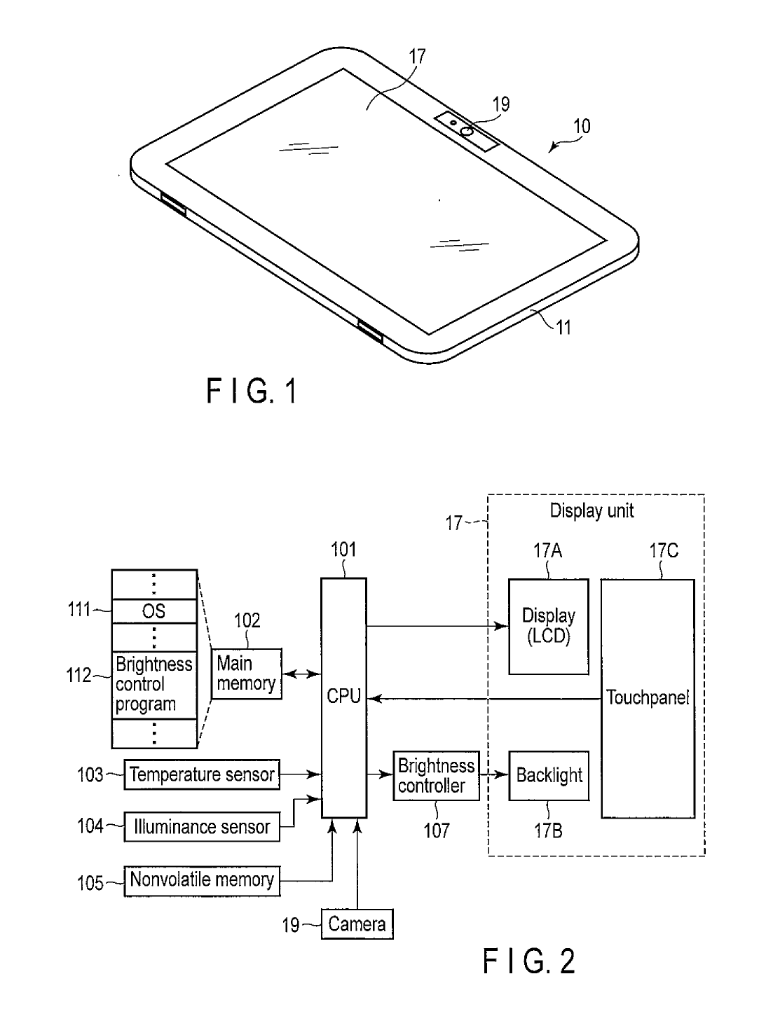

Now, a system configuration of the computer 10 will be described with reference to FIG. 2.

The computer 10 comprises a CPU 101, a main memory 102, a temperature sensor 103, an illuminance sensor 104, a nonvolatile memory 105, and a brightness controller 107. Furthermore, the touchscreen display 17 is implemented as a display unit including a display 17A such as an LCD, a backlight 17B, and a touchpanel 17C.

The CPU 101 is a processor that controls the operation of respective components in the computer 10. The CPU 101 executes an operating system (OS) 111 and various applications and utility programs which are loaded from the nonvolatile memory 105 into the main memory 102. The applications and utility programs include a brightness control program 112.

The brightness control program 112 is a brightness control module configured to carry out the above-described brightness control function in cooperation with the CPU 101, the temperature 103, and the brightness controller 107. The brightness control program 112 controls the brightness of the touchscreen display 17 (LCD 17A) based on a temperature detected by the temperature sensor 103.

The temperature sensor 103 detects the temperature of a predetermined position in the housing of the computer main body 10. The temperature sensor 103 may be located near the CPU 101 so as to be able to detect the temperature around the CPU 101. Alternatively, the temperature sensor 103 may be located near the surface of the housing of the computer main body 10.

The illuminance sensor 104 detects the illuminance of ambient light present around the computer 10. The illuminance sensor 104 is used to adjust the brightness of the display (LCD) 17A, that is, the brightness of the backlight 17B, according to the illuminance of the ambient light.

The brightness controller 107 controls the brightness of the backlight 17B under the control of the CPU 101. The CPU 101 supplies the brightness controller 107 with a digital signal (e.g., pulse-width modulation [PWM] signal) corresponding to a predetermined brightness value. The brightness controller 107 receives the PWM signal from the CPU 101 and supplies the backlight 17B with a current corresponding to the duty ratio of the received PWM signal. The brightness of the backlight 17B, that is, the brightness of the touchscreen display 17, is varied depending on the amount of current supplied to the backlight 17. In this case, the brightness of the backlight 17B increases consistently with the amount of current supplied to the backlight 17B.

The OS 111 has a brightness adjustment function to adjust the brightness of the touchscreen display 17. That is, the OS 111 functions as a brightness adjustment module that adjusts the brightness of the touchscreen display 17 in cooperation with the CPU 101 and the brightness controller 107 so that the brightness is set to a brightness value specified by user operation.

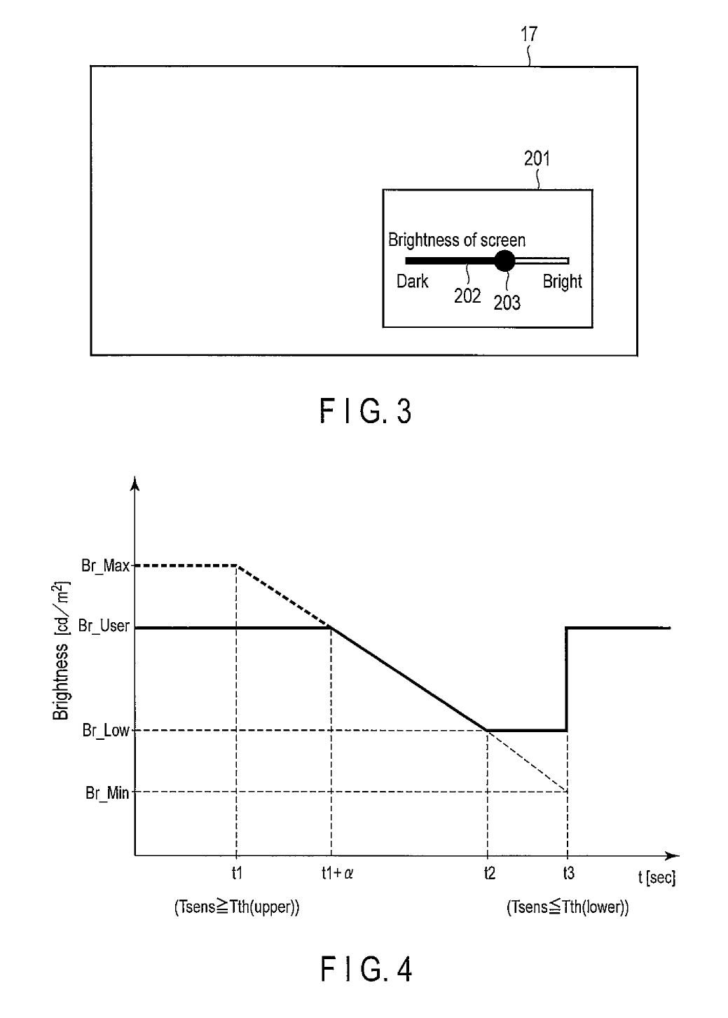

As shown in FIG. 3, the brightness adjustment module displays a brightness adjustment screen (slider) 201 on the touchscreen display 17. The brightness adjustment screen 201 is a graphical user interface element configured to allow the user to specify the brightness of the touchscreen display 17. The brightness adjustment screen 201 comprises a brightness bar (track) 202 and a slide button (thumb) 203. When the user moves the slide button 203 leftward, the brightness of the touchscreen display 17 decreases. When the user moves the slide button 203 rightward, the brightness of the touchscreen display 17 increases. A brightness range applicable to the touchscreen display 17 has a maximum value of, for example, 350 cd/m² and a minimum value of, for example, 60 cd/m². The user can specify any value within the brightness range as the brightness value of the touchscreen display 17.

The brightness adjustment module can further automatically adjust the brightness of the touchscreen display 17 according to the ambient light. If an automatic adjustment mode is enabled, the brightness adjustment module automatically adjusts the brightness of the touchscreen display 17, that is, the brightness of the backlight 17B, according to the illuminance (brightness) of the ambient light detected by the illuminance sensor 104. In this case, the brightness of the touchscreen display 17 increases consistently with the illuminance of the ambient light.

In order to limit the brightness of the touchscreen display 17 to a certain given value or less, the brightness control program 112 reduces the upper limit value of the brightness range applicable to the touchscreen display 17 if the temperature of the housing detected by the temperature sensor 103 is greater than or equal to a first threshold value. The upper limit value of the brightness range is indicative of the upper limit value of the brightness which can be set for the touchscreen display 17. Thus, if the current brightness value is greater than the upper limit value of the brightness, the brightness of the touchscreen display 17 is reduced to the upper limit value of the brightness. If the current brightness value is less than or equal to the upper limit value of the brightness, the current brightness value is maintained without change.

More specifically, the brightness control program 112 compares the brightness value specified by user operation with the upper limit value of the brightness determined under the control of the brightness control program 112. The brightness control program 112 then sets the brightness of the touchscreen display 17 to the lesser brightness value of the brightness value specified by user operation and the upper limit value.

Thus, the reduced upper limit value of the brightness allows an excessive rise in the surface temperature of the housing to be suppressed.

If the upper limit value of the brightness decreases rapidly, the screen of the touchscreen display 17 darkens abruptly, possibly making the user feel uncomfortable. Thus, the embodiment reduces the upper limit value of the brightness at a predetermined rate of decrease so as to gradually lower the brightness of the touchscreen display 17 with the elapse of time. The rate of decrease is set to a predetermined value at which the upper limit value of the brightness decreases from the maximum value to minimum value of the brightness range in a predetermined time. The rate of decrease may be value at which the brightness value decreases by several cd to several tens of cd per second.

Now, a brightness control operation that is performed by the brightness control program 112 will be described with reference to FIG. 4.

FIG. 4 shows a variation in the brightness of the touchscreen display 17 during a brightness control operation. In FIG. 4, the axis of ordinate indicates the brightness of the touchscreen display 17. The axis of abscissas indicates time. In FIG. 4, the maximum value of the brightness range applicable to the touchscreen display 17 is denoted by Br_Max, and the minimum value of the brightness range is denoted by Br_Min. The lower limit value of the brightness for use in the brightness control operation is denoted by Br_Low. The brightness value specified by the user is denoted by Br_User. It is assumed that the brightness of the touchscreen display 17 is set to the user specified brightness value Br_User. The brightness value Br_User is any value between the maximum value Br_Max and the minimum value Br_Min.

At timing t1, a temperature Tsens detected by the temperature sensor 103 is greater than or equal to a first threshold value Tth (upper). The brightness control program 112 starts a brightness control operation. The brightness control program 112 gradually reduces the upper limit value of the brightness from the maximum value Br_Max toward the minimum value Br_Min. The rate of decrease may be, for example, any value between several cd/m² and several tens of cd/m² as described above.

The upper limit value of the brightness remains greater than or equal to the brightness value Br_User until timing t1+α is reached. Thus, the brightness of the touchscreen display 17 is maintained at the brightness value Br_User. When the user moves the slide button (thumb) 203 rightward, the brightness of the touchscreen display 17 can be increased to the current upper limit value of the brightness.

The upper limit value of the brightness is reduced at the above-described rate of decrease. At timing t1+α, the upper limit value of the brightness is equal to the brightness value Br_User. After timing t1+α, the upper limit value of the brightness is less than the brightness value Br_User. Thus, the brightness control program 112 sets the upper limit value of the brightness for the touchscreen display 17. Hence, after timing t1+α, the brightness of the touchscreen display 17 decreases linearly at the above-described rate of decrease.

At timing t2, the current upper limit value of the brightness is reduced to the lower limit value of the brightness Br_Low. Although the brightness of the touchscreen display 17 can be reduced to the minimum value Br_Min, the brightness control program 112 maintains the brightness of the touchscreen display 17 at the lower limit value of the brightness Br_Low instead of reducing the brightness of the touchscreen display 17 below the lower limit value of the brightness Br_Low. Thus, the visibility of the screen of the touchscreen display 17 can be prevented from decreasing.

For example, at timing t3, the temperature Tsens detected by the temperature sensor 103 decreases to a second threshold value Tth (lower). The second threshold value Tth (lower) has been set less than the first threshold value Tth (upper). At timing t3, the brightness control program 112 sets the brightness of the touchscreen display 17 to the brightness value Br_User. The brightness control program 112 then stops the brightness control operation. This allows the brightness of the touchscreen display 17 to be reset to the brightness value Br_User.

If the automatic adjustment mode has been enabled, then at timing t1, the brightness control program 112 disables the automatic adjustment mode. The brightness value used in the automatic adjustment mode may be used without change until the upper limit value of the brightness decreases to the brightness value used in the automatic adjustment mode. When the upper limit value of the brightness decreases below the brightness value used in the automatic adjustment mode, the brightness of the touchscreen display 17 is set to the brightness value indicated by the upper limit value of the brightness. Thus, the brightness of the touchscreen display 17 decreases linearly at the above-described rate of decrease. When the temperature Tsens detected by the temperature sensor 103 decreases to the second threshold value Tth (lower), the brightness control program 112 enables the automatic adjustment mode again. The brightness control program 112 then stops the brightness control operation. Thus, the brightness of the touchscreen display 17 is reset to the value corresponding to the illuminance of the ambient light.

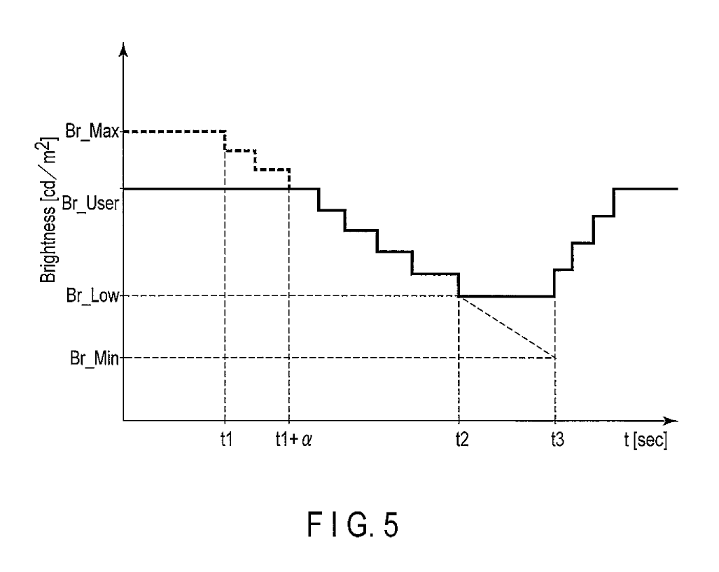

With reference to FIG. 4, the example has been described in which the upper limit value of the brightness is linearly reduced. However, as shown in FIG. 5, the upper limit value of the brightness may be reduced in a step-by-step manner. Furthermore, in FIG. 4, when the temperature Tsens detected by the temperature sensor 103 decreases to the second threshold value Tth (lower), the brightness of the touchscreen display 17 is immediately reset to the original value. However, as shown in FIG. 5, the brightness of the touchscreen display 17 may be gradually increased to the original value. In this case, the brightness of the touchscreen display 17 may be increased linearly or in a step-by-step manner as shown in FIG. 5.

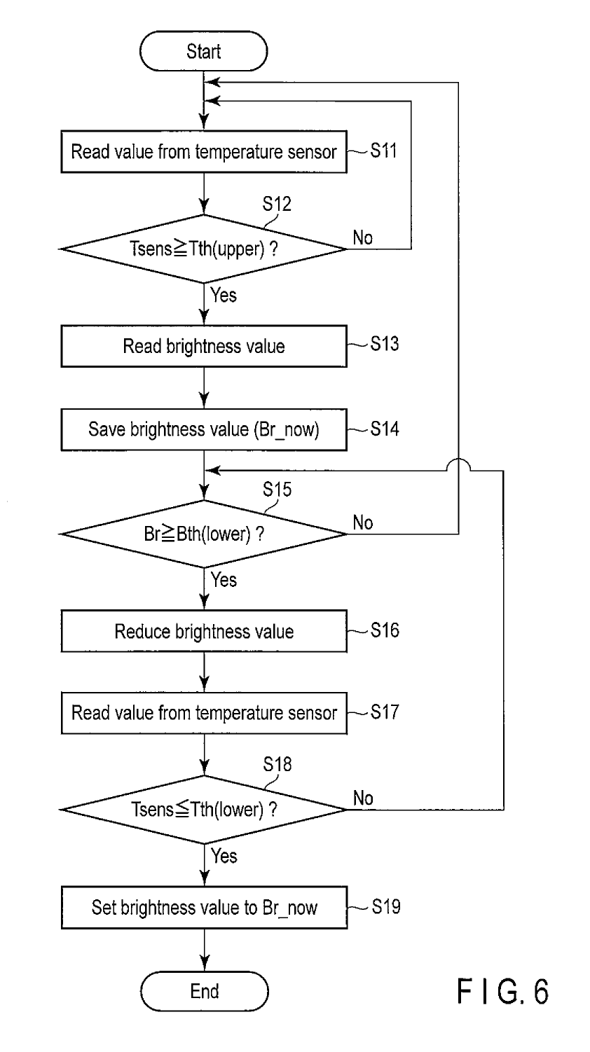

Now, a procedure for a brightness control process that is carried out by the brightness control program 112 will be described with reference to a flowchart in FIG. 6.

The brightness control program 112 monitors the temperature detected by the temperature sensor 103. That is, the brightness control program 112 periodically reads the temperature within the housing detected by the temperature sensor 103 (step S11). The brightness control program 112 then determines whether or not the temperature within the housing Tsens is greater than or equal to the first threshold value Tth (upper) (step S12).

If the temperature within the housing Tsens is greater than or equal to the first threshold value Tth (upper), the brightness control program 112 reads the current brightness value Br_now of the touchscreen display 17 (step S13). Then, the brightness control program 112 saves the read current brightness value Br_now to a storage device such as the main memory 102 (step S14). The current brightness value Br_now is the user specified brightness value, a default value, or the brightness value corresponding to the illuminance of the ambient light.

The brightness control program 112 determines whether or not the current upper limit value of the brightness Br is greater than or equal to the lower limit value of the brightness Br_Low (in FIG. 6, the lower limit value of the brightness is denoted as Bth (lower)) (step S15).

If the current upper limit value of the brightness Br is greater than or equal to the lower limit value of the brightness Br_Low, the brightness control program 112 reduces the current upper limit value of the brightness Br (step S16). In step S16, a new upper limit value of the brightness Br is calculated by subtracting a predetermined value from the upper limit value of the brightness Br. Then, in step S16, the brightness control program 112 compares the brightness value Br_now with the new upper limit value of the brightness Br to determine whether or not the new upper limit value of the brightness Br is less than the brightness value Br_now. If the new upper limit value of the brightness Br is less than the brightness value Br_now, the brightness control program 112 transmits a PWM signal corresponding to the new upper limit value of the brightness Br to the brightness controller 107. This allows the brightness of the touchscreen display 17 to be set to a value corresponding to the new upper limit value of the brightness. On the other hand, if the new upper limit value of the brightness Br is greater than or equal to the brightness value Br_now, the brightness of the touchscreen display 17 is not changed but maintained at the brightness value Br_now.

The brightness control program 112 determines whether or not the temperature Tsens within the housing detected by the temperature sensor 103 is greater than or equal to the second threshold value Tth (lower) (step S108). If the temperature Tsens within the housing is higher than the second threshold value Tth (lower), the processing between step S15 and step S17 is repeatedly carried out. Thus, the brightness of the touchscreen display 17 decreases gradually with the elapse of time.

If the temperature Tsens within the housing is less than or equal to the second threshold value Tth (lower), the brightness control program 112 transmits a PWM signal corresponding to the brightness value Br_now to the brightness controller 107. This allows the brightness of the touchscreen display 17 to be reset to a value corresponding to the brightness value Br_now (step S19).

As described above, according to the present embodiment, when the temperature within the housing is greater than or equal to the first threshold value, the upper limit value of the brightness range applicable to the touchscreen display 17 (the upper limit value of the brightness) is automatically reduced. Since the upper limit of the brightness adjustment range of the touchscreen display 17 is thus reduced, if the current brightness-value is greater than the upper limit value of the brightness, the brightness of the touchscreen display 17 is reduced to the upper limit value of the brightness. This enables a reduction in the amount of heat generated by the touchscreen display 17 (the amount of heat generated by the backlight 17b), allowing a rise in the surface temperature of the housing to be suppressed. On the other hand, if the current brightness value is less than or equal to the upper limit value of the brightness, that is, the amount of heat generated by the touchscreen display 17 (the amount of heat generated by the backlight 17b) is relatively little, the current brightness value is maintained without change. This prevents a decrease in the visibility of the screen of the touchscreen display 17 which is caused by an unnecessary reduction in brightness.

All of the process procedure according to the present embodiment can be executed by software. Thus, effects similar to those of the present embodiment can be easily exerted simply by installing a computer program that carries out the process procedure, in a normal computer with a touchscreen display through a computer readable storage medium having stored thereon the program, and then executing the program.

Furthermore, in the present embodiment, the brightness control section and the brightness adjustment module may be implemented using hardware such as DSP or a microcomputer.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A portable electronic device comprising:
a housing comprising a processor;
a touchscreen display on a surface of the housing;
a temperature sensor configured to detect a temperature in the housing;
a brightness adjustment module configured to adjust a brightness of the touchscreen display to set the touchscreen display to a brightness value specified by a user operation; and
a brightness control module configured to reduce an upper limit of a brightness range of the touchscreen display if the detected temperature is greater than or equal to a first value.

2. The portable electronic device of claim 1, wherein the brightness control module is configured to compare the brightness value specified by the user operation with the upper limit of the brightness range and to set the brightness of the touchscreen display to a lesser of the brightness value specified by the user operation and the upper limit of the brightness range.

3. The portable electronic device of claim 1, wherein the brightness control module is configured to reduce the upper limit of the brightness range at a first rate of decrease at which the upper limit of the brightness range decreases from a maximum to a minimum of the brightness range in a first time.

4. The portable electronic device of claim 2, wherein the brightness control module is configured to reduce the upper limit of the brightness range at a first rate of decrease at which the upper limit of the brightness range decreases from a maximum to a minimum of the brightness range in a first time.

5. The portable electronic device of claim 1, wherein the brightness control module is configured to save the brightness value specified by the user operation and to reset the brightness of the touchscreen display to the saved brightness value if the detected temperature decreases to a second value after the upper limit of the brightness range is reduced, the second value being less than the first value.

6. The portable electronic device of claim 3, wherein the brightness control module is configured to linearly reduce the upper limit of the brightness range.

7. The portable electronic device of claim 3, wherein the brightness control module is configured to step-by-step reduce the upper limit of the brightness range.

8. The portable electronic device of claim 1, further comprising a sensor configured to detect an illuminance of ambient light,
wherein the brightness adjustment module is further configured to adjust the brightness of the touchscreen display according to the detected illuminance if an automatic adjustment mode is enabled, and
wherein the brightness control module is configured to disable the automatic adjustment mode if the detected temperature is greater than or equal to the first value and to enable the automatic adjustment mode if the detected temperature decreases to a second value after the upper limit of the brightness range is reduced, the second value being less than the first value.

9. A method of brightness control for a portable electronic device comprising a housing, a processor, and a touchscreen display on a surface of the housing, the method comprising:
adjusting a brightness of the touchscreen display to set the touchscreen display to a brightness value specified by a user operation;
detecting a temperature in the housing a temperature sensor; and
reducing an upper limit of a brightness range of the touchscreen display if the detected temperature is greater than or equal to a first value.

10. The method of claim 9, further comprising:
comparing the brightness value specified by the user operation with the upper limit of the brightness range; and
setting the brightness of the touchscreen display to a lesser of the brightness value specified by the user operation and the upper limit of the brightness range.

11. A non-transitory computer-readable storage medium that stores executable program instructions that direct a computer comprising a housing, a processor, and a touchscreen display on a surface of the housing, to perform a process that comprises:
adjusting a brightness of the touchscreen display to set the touchscreen display to a brightness value specified by a user operation;
detecting a temperature in the housing a temperature sensor; and
reducing an upper limit of a brightness range of the touchscreen display if the detected temperature is greater than or equal to a first value.
